(19) United States
(12) Patent Application Publication
(10) Pub. No.: US 2014/0010622 A1
(43) Pub. Date: Jan. 9, 2014

(54) Fork Lift Apparatus

(71) Applicant: Richard J. Mizner, Phoenix, AZ (US)

(72) Inventor: Richard J. Mizner, Phoenix, AZ (US)

(21) Appl. No.: 13/692,902

(22) Filed: Dec. 3, 2012

Related U.S. Application Data
(63) Continuation-in-part of application No. 10/958,520, filed on Oct. 4, 2004, now Pat. No. 8,322,968.
Application No. 10/958,520 is a continuation-in-part of application No. 11/207,137, filed on Aug. 17, 2005.
Application No. 11/207,137 is a continuation-in-part of application No. 11/440,865, filed on May 24, 2006.

(51) Int. Cl. B66F 9/08; B66F 9/06

(52) U.S. Cl. CPC B66F 9/082; B66F 9/06
USPC 414/634

(57) ABSTRACT

A fork lift for attachment to a truck frame of a truck, include A first mounting beam carried by the truck frame, a detachable attachment mechanism connecting the mounting beam to the truck frame, the detachable attachment mechanism extending through a truck body of the truck, a fork lift mast pivotably connected to the mounting beam, and a tilt actuator connected between the mounting beam and fork lift mast.

### CROSS-REFERENCE TO RELATED APPLICATIONS

This application claims the benefit of U.S. Provisional Application No. 60/553,610, entitled “TRUCK FORK LIFT, METHODS, AND ASSOCIATED DEVICES”, which was filed on Mar. 15, 2004, the contents of which are incorporated by reference as though fully set forth herein.

This application is a continuation-in-part of U.S. patent application Ser. No. 10/958,520, entitled “FORK LIFT FOR TRUCKS, METHODS, AND ASSOCIATED DEVICES”, which was filed on Oct. 4, 2004, the contents of which are incorporated by reference as though fully set forth herein. U.S. patent application Ser. No. 10/958,520 issued as U.S. Pat. No. 8,322,968 on Dec. 4, 2012.

This application is a continuation-in-part of U.S. patent application Ser. No. 11/207,137, entitled “FORK LIFT ATTACHMENT TOOLS AND METHODS”, which was filed on Aug. 17, 2005, the contents of which are incorporated by reference as though fully set forth herein.

This application is a continuation-in-part of U.S. patent application Ser. No. 11/440,865, entitled “TRUCK FORK ATTACHMENT INCLUDING ADJUSTABLE MAST FOR GROUND CLEARANCE”, which was filed on May 24, 2006, the contents of which are incorporated by reference as though fully set forth herein.

### BACKGROUND OF THE INVENTION

1. Field of the Invention

This invention relates generally to a fork lift that is mountable to a vehicle for material and article handling.

2. Description of the Related Art

There are many different types of vehicles, which are useful for material and article handling. Several examples can be found in U.S. Pat. Nos. 4,177,001 to Blackwood, 4,325,666 to Chain, 4,365,921 to Brouwer, 4,388,037 to Suarez, 4,463,858 to Bilas, 4,778,327 to Tufenkian, 5,208,753 to Acuff 5,391,043 to Bohata, 5,951,236 to Thompson, 6,234,741 to McDaniel, 6,612,615 to Dimand, 7,033,128 to Poindexter, 7,318,541 to Fraer, as well as U.S. Patent Application No. 2005/0129494 to Chandler, 2006/0231581 to Jones and 2007/0166138 to Brooks. While the vehicles disclosed in these references is suitable for their intended purposes, what is needed is a vehicle which can handle heavier material and articles.

### BRIEF SUMMARY OF THE INVENTION

The present invention is directed to a vehicle for handling material and articles. The novel features of the invention are set forth with particularity in the appended claims. The invention will be best understood from the following description when read in conjunction with the accompanying drawings.

### BRIEF DESCRIPTION OF THE DRAWINGS

It should be noted that like reference characters are used throughout the several views of the drawings.

FIG. 1A is a perspective and diagrammatic view of a truck fork lift mounted in a truck.

FIG. 1B is a diagrammatic perspective view of the truck fork lift of FIG. 1A separated from the truck.

FIG. 1C is diagrammatic perspective view of a portion of the truck fork lift of FIG. 1B with the forks in a lowered position and showing additional details.

FIG. 2A is a diagrammatic perspective view of a tool box, configured according to the embodiment of FIG. 1 of the present invention, that advantageously helps to support the truck fork lift in the truck.

FIG. 2B is a diagrammatic top plan view of the tool box and beams of FIG. 2A with the tool box in an open empty condition.

FIG. 2C is a detailed diagrammatic top plan view of a portion 2C of FIG. 2B with the tool box in a use condition containing components of the present invention.

FIG. 2D is a diagrammatic top plan view of a control box.

FIG. 2E is a diagrammatic top plan view of a control box and transceiver.

FIG. 3A is a diagrammatic perspective view of a trailer.

FIG. 3B is a diagrammatic side view of the truck fork lift of FIG. 1A and a portion of a trailer in accordance with FIG. 3A.

FIG. 3C is a diagrammatic front plan view of the trailer of FIG. 3B.

FIG. 3D is a diagrammatic rear plan view of the truck fork lift of FIG. 3B.

FIG. 4A is a more detailed diagrammatic perspective view of a pallet buggy in accordance with that shown in FIG. 3A.

FIG. 4B is a top plan view of the pallet buggy of FIG. 4A.

FIG. 4C is a front plan view of the pallet buggy of FIG. 4B taken in a direction of arrow 4C.

FIG. 5A is a diagrammatic side view of the fork lift stanchion for supporting the fork lift of FIGS. 1A, 1B and 1C in a condition separate from the truck.

FIG. 5B is a diagrammatic top plan view of the fork lift stanchion of FIG. 5A.

FIG. 5C is a diagrammatic side view of the fork lift stanchion of FIG. 5A for supporting the fork lift of FIGS. 1A, 1B and 1C in a condition separate from the truck.

### DETAILED DESCRIPTION OF THE INVENTION

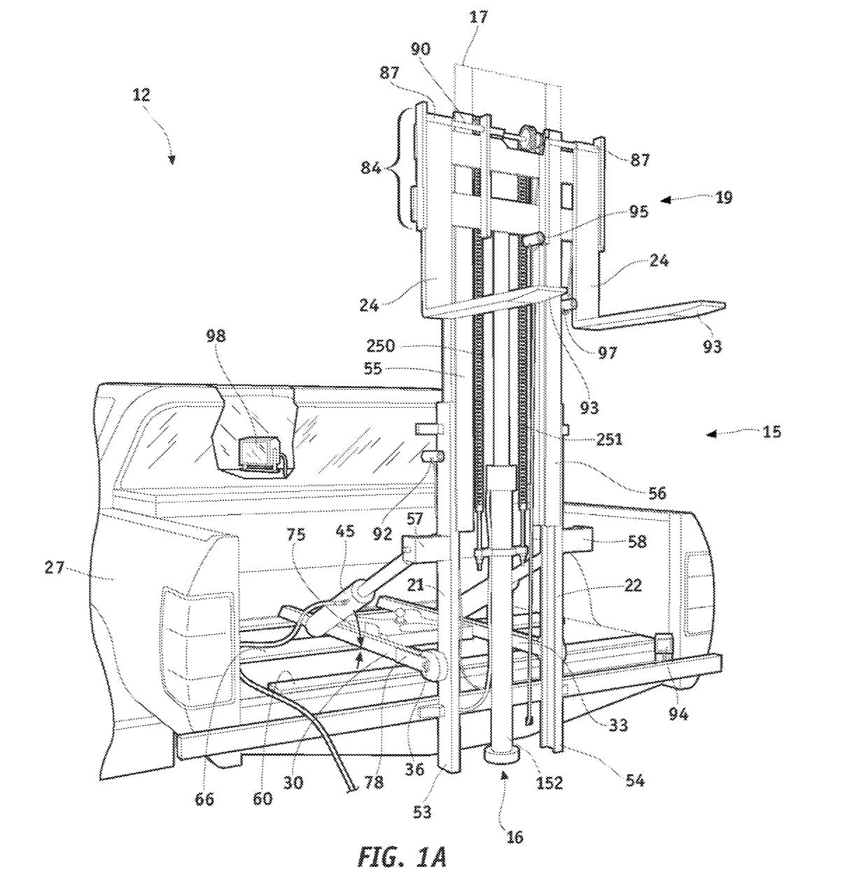

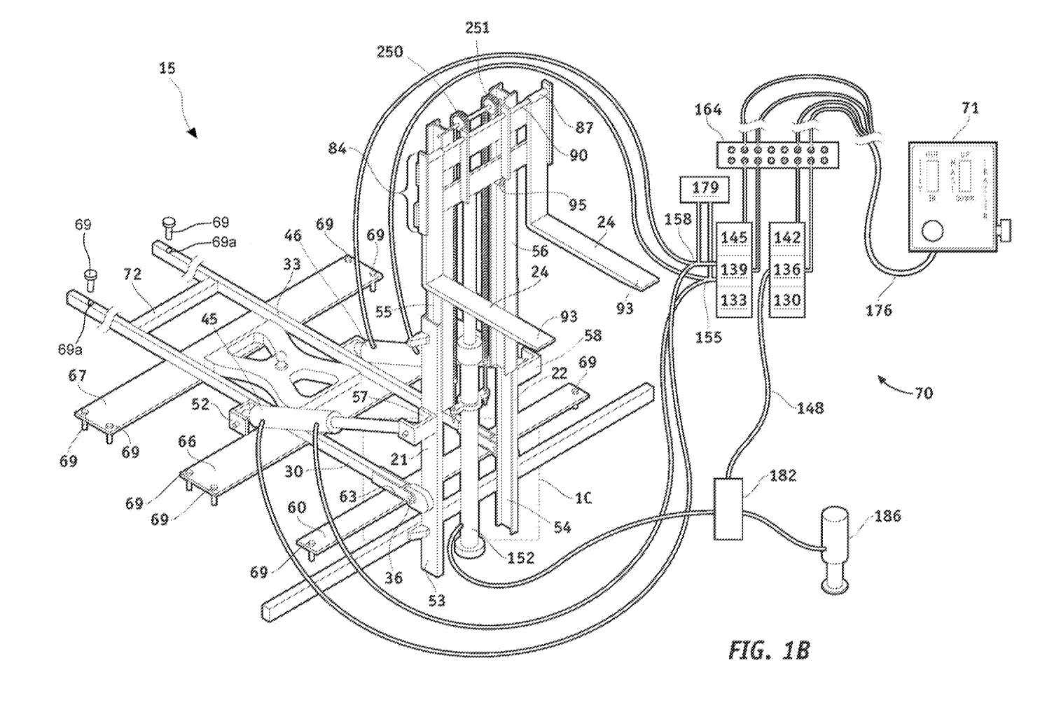

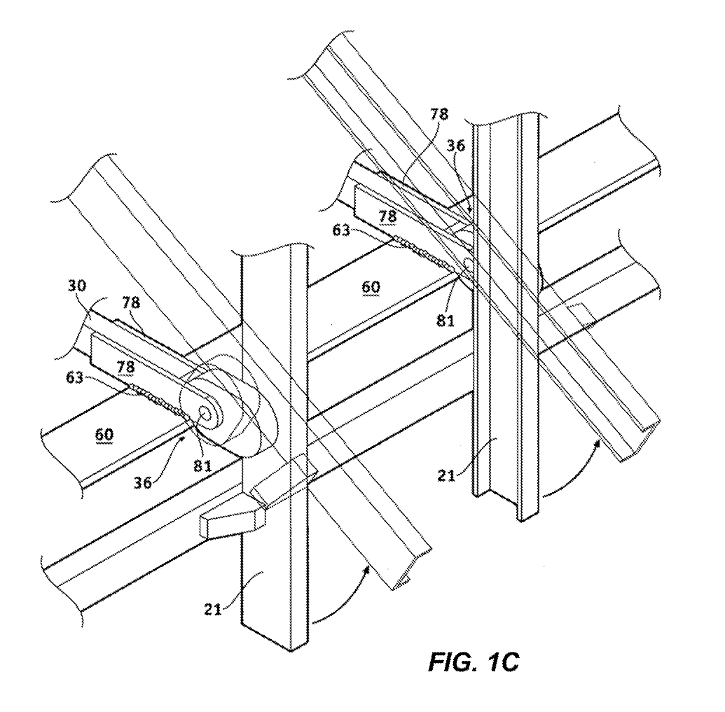

As shown in FIG. 1A, a truck fork lift 12 facilitates easier, faster, and safer loading and transport of medium sized loads. Medium sized loads for the purposes of the present invention is defined as loads having the weight in a range from approximately 200 pounds to approximately 3,000 pounds. The fork lift 15 is a fork lift having a capacity rating of 1,000 to 7,000 pounds. The fork lift 15 is an extensible fork lift as indicated by the break line and dashed extension at 17 in FIG. 1A. Likewise, the pickup truck 18 is a truck having a manufacturer's rating of 3,400 to 7,000 pounds. Alternatively, the pickup truck is modified to include a suspension with a 5,000 pound rating or a 7,000 pound rating, for example. Larger trucks and fork lifts having higher capacity ratings can also be implemented in accordance with the present invention. Nevertheless, loads weighing in the range from approximately 200 pounds to approximately 7,000 pounds is lifted by the lifts of the present invention.

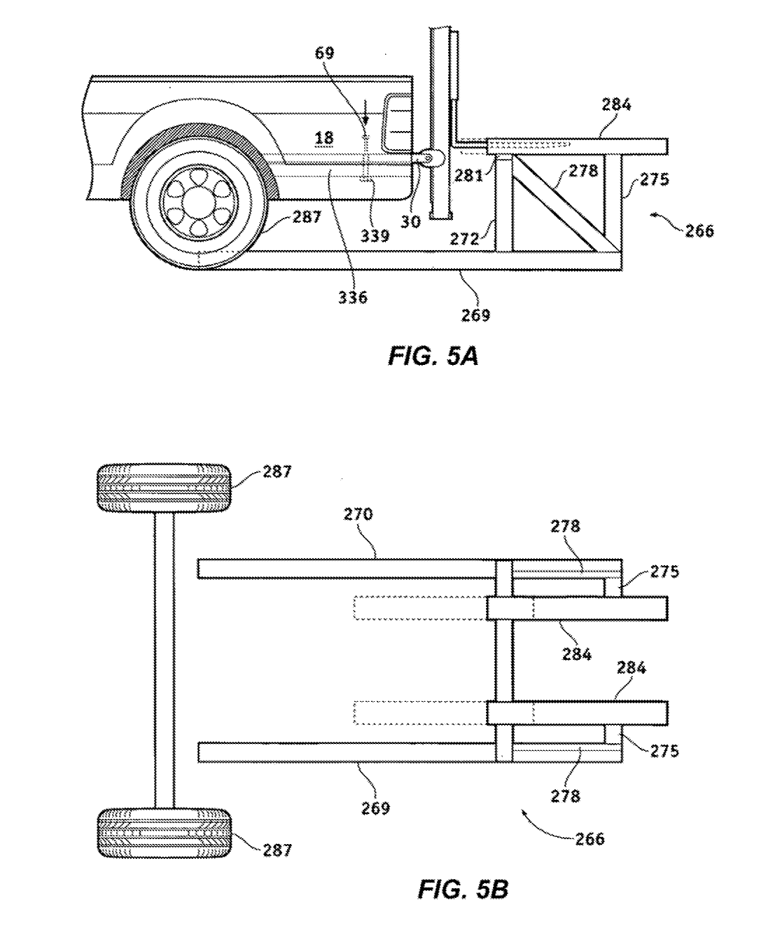

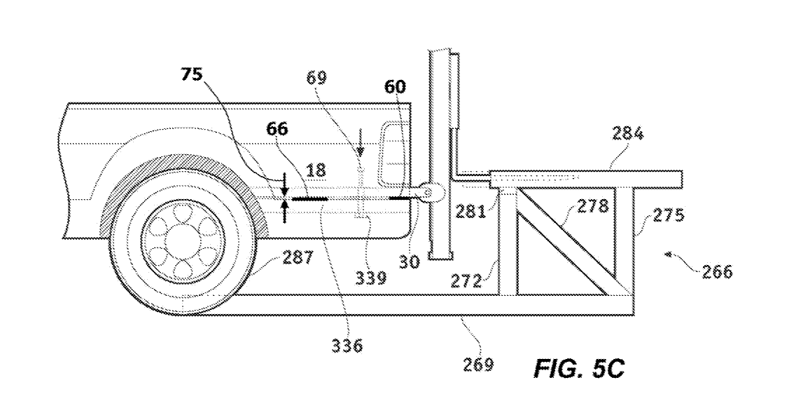

As shown, the truck fork lift 12 includes fork lift masts 21 and 22 and forks 24. The masts 21 and 22 are pivotally supported on the truck bed 27 by a pair of fore and aft extending channel beams 30 and 33, respectively. These beams 30, 33 are mounted to the truck frame or chassis 336 (FIG. 5A) by bolts or other mounting structure that passes through the bed of the truck. Alternatively, the beams 30, 33 can form part of the chassis. This is accomplished by modifying the truck frame to include the beams 30, 33, or the beams 30, 33 are incorporated as part of the chassis during the original manufacture of the vehicle. Pivot connections 36 and 37 (FIG. 1C), which are at the rear end of the bed 27, and beams 30, 33 enable masts 21 and 22, respectively, to rotate from the vertical position of use shown in FIG. 1A into a stored and transport position laying more or less flat in the bed 27. Hydraulic rams 45 and 46 are connected to the beams 30 and 33, respectively, and to corresponding masts 21 and 22 for selectively moving the fork lift 15 from a vertically oriented position of use to a stowed position of transport with the mast lying generally flat or in an overlying relation in the bed 27 of the truck.

Other arrangements can alternatively be implemented for raising and lowering the fork lift masts 21 and 22 relative to the beams 30, 33 and the bed 27 of the truck. One such arrangement involves the hydraulic ram 45 connected to a linkage that extends between and is connected to each of the mast 21, and the beams 30, 33. In this linkage version, the linkage arms are moved from a doubled condition into a relatively straight condition as the fork lift mast 21 is moved from a stowed position into a vertical position of use. In any case, one or more tilt rams 45 are incorporated, and the hydraulic rams 45 and 46 can also provide tilting adjustment of the mast 21 during use such as for positioning the forks in order to lean a load toward the mast during transport. The tilt ram(s) 45 is mounted to a block or mounting plate 52 connected to the beams 30, 33 or to the truck frame generally at or below the level of the truck bed 27, as shown in FIG. 1B. Furthermore, the pivot connection 36 of the mast is close to the level of the bed 27 so that the mast is pulled and pushed in and out of an overlying relationship relative to the truck bed 27 and beams 30, 33.

Further alternatively, one or more hydraulic rams 45 is positioned under the bed 27 of the truck and connected to a lower end 53 of the mast 21. While this configuration has the advantage of enabling a lower profile stowed position of the mast 21 in the truck bed 27, locating the hydraulic rams 45 under the bed 27 and connecting them to the frame of the truck will occupy a space that otherwise would be used for storage of a spare tire.

In one exemplary embodiment, a suspension of the truck 18 includes six main springs and five overload springs at each of the rear wheels. The springs is adjusted so that the lowest overload spring is in a range from approximately one half to three fourths of an inch above the lowest main spring. In this configuration, the truck will only squat slightly before engaging the overload springs. For example, the truck 18 having this spring configuration and having the truck fork lift 15 and associated components on the truck 18 without any additional load squats just enough to engage or almost engage the overload springs. This is important in order to ensure that the truck maintains a proper clearance for a lower end 53 of the fork lift mast. As is appreciated from FIG. 1A, the lower end 53 of the mast has a clearance of approximately twelve to fourteen inches in a non-loaded state. When fully loaded, the rear suspension of the truck will engage the overload springs and will only squat approximately four inches, leaving a minimum of approximately eight inches of clearance from the ground. This amount of clearance is excellent when compared to a regular clearance in a range from approximately three to four inches between a lower end of a mast and the ground for a standard fork lift. Standard fork lifts are configured to have the forks extend downwardly a maximum of approximately two to four inches from the lower end of the mast. The capability of extending the forks downwardly from the lower end of the mast enables the forks to engage or nearly engage the ground so that they slide under low set loads, such as when stabbing the forks into and engaging a pallet. With the mast 21 of the present invention, the forks must be extended downwardly by approximately fifteen inches more than standard forks in order to compensate for the clearance between the lower end 53 of the mast 21 and the ground. With this clearance and these modifications, the truck fork lift 12 is well adapted for any terrain having medium to great contours. For example, the truck fork lift 12, having a fourteen inch non-loaded clearance for the lower end 53, backs a load of three thousand to three thousand eight hundred pounds down a twenty degree slope into a garage having a level floor and maintain a clearance of nine inches or more.

As shown in FIG. 1B, the fork lift 15 is provided as a separate apparatus that is retrofitted to an existing truck. Alternatively, the fork lift 15 is provided as an integral part of a truck during manufacture. In either case, all or part of the fork lift 15 is easily removed to enable more space and/or other uses of the truck bed 27, such as for hauling loads that will not otherwise fit in the bed 27. In FIG. 1B, the fork lift is shown as a separate apparatus that is removed together with the beams 30, 33. The beams 30 and 33 that support the truck fork lift 15 is welded or otherwise attached to flat stock material 60 as shown by welds at 63. While the flat stock material 60 is shown as a laterally extending strip near a rear end of the bed 27 and beams 30, 33 in FIGS. 1A and 1B, the flat stock material could alternatively cover a larger area of the bed 27. In fact, the flat stock material could cover almost an entire area of the bed 27. Further alternatively, the flat stock material could be provided in selected areas such as at 66 and/or 67, which corresponds to underlying cross members in a frame of the truck 18. Thus, bolts 69 are used to connect the flat stock material 60 to the underlying cross members of the truck frame or chassis. In this embodiment, the fork lift 15 includes flat stock material 60 positioned between the first and second mounting beams 30 and 33 and the truck bed 27. In some embodiments, the first and second detachable attachment mechanisms 69 are spaced apart from the flat stock material 60.

Bolts 69 are used to connect mounting beams 30 and 33 to truck frame or chassis 336 (FIG. 5A) of truck fork lift 12, as shown in FIGS. 1B, 5A and 5B, wherein bolts 69 extend through mounting beams 30 and 33 and truck bed 27.

A hydraulic actuation system 70 including a control box 71 is shown schematically in FIG. 1B. The hydraulic actuation system includes pumps, solenoids, motors, hydraulic lines, and electric lines all connected as will be described below. The control box 71 is shown in a particular configuration in FIG. 1B, which functions substantially in accordance with the other embodiments described more particularly below. In any case, the control box 71 has controls for actuating the hydraulic pumps and solenoids to move the fork plate up and down and the tilt the mast in and out.

A beam cross member 72 is provided to connect the beams 30 and 33 for greater stability and strength. Furthermore, a space 75 is provided between a majority of the beams 30 and 33 and the bed 27 of the truck. This space 75 advantageously enables the beams 30 and 33 to flex under the heavy loads that will be applied thereto during use. It is to be understood that the flat stock material 60, 66, 67, cross member 72, and other structural members alternatively include strengthening contours in order to advantageously increase a strength to weight ratio of the mounting and strengthening structure of the fork lift 15 and the truck frame. Hence, in this embodiment, the first and second mounting beams 30 and 33 are spaced apart from the truck bed 27. In these embodiments, the mounting beams 30 and 33 are positioned above the truck bed 27 of the truck 18, as shown in FIG. 1A.

As shown in FIG. 1C, a pair of frame members 78 straddles each of the mounting beams 30 and 33 and form brackets with pivot holes 81 for the pivot connections 36 with the mast 21. A fork plate 84 is slideably supported on the mast 21 in a known manner. Forks 24 is supported on the fork plate 84. As shown in FIGS. 1A and 1B, the forks 24 is pivotally and slideably connected to the fork plate 84 by sleeves 87 that engage a rod 90 of the fork plate 84. Thus, when the mast 21 is folded into the stowed position lying generally flat in the bed 27 of the truck 18, the forks 24 can be manually rotated so that tips 93 rotate and engage the bed 27 of the truck 18.

It should be noted that the operator of truck fork lift 12 faces away from the rear of the vehicle during normal operation. However, fork lift carriage 19 faces rearwardly from the vehicle when fork lift carriage 19 is used to raise and lower a load. Hence, the operator of the pickup truck and fork lift carriage 19 face in opposed directions when fork lift carriage 19 is used to raise and lower a load.

As shown in FIGS. 1A and 1C, the truck fork lift 15 further includes a viewing mechanism with at least one of a camera 92 or a mirror supported on the mast, for example. One or more additional cameras 94, 95, 97 or mirrors is mounted on the fork plate 84 or fork 24. These cameras 92, 94, 95, 97, and/or mirrors, is provided for viewing the relationship between the truck fork lift 15, forks 24, and a load during stabbing of the forks 24. A monitor 98 is remotely located in the cab of the truck, for example, for viewing by a driver also located in a cab. The monitor 98 displays images captured by the at least one camera 92, 94, 95, 97 for viewing by a driver while seated in the cab and operating the truck to stab the fork. When mirrors are implemented, it is to be understood that a durable stainless steel device can provide a durable yet effective mirror.

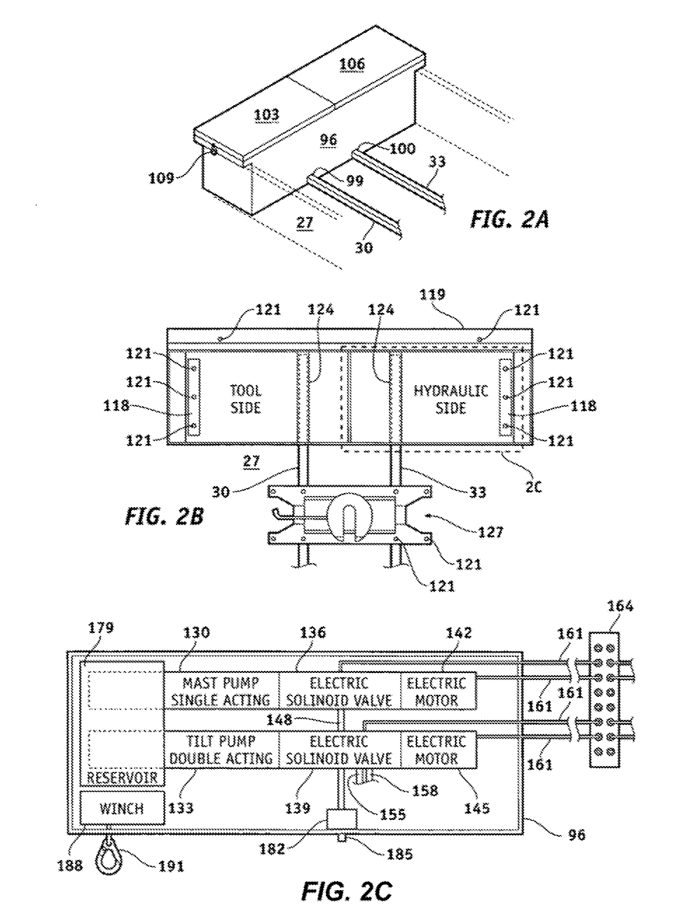

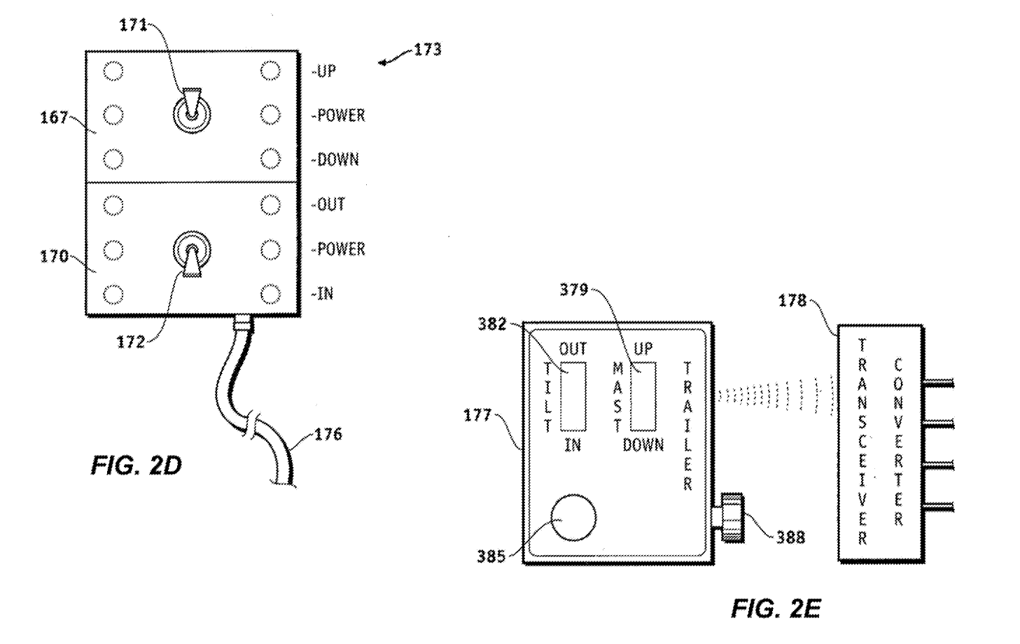

As shown in FIG. 2A, forward ends of the beams 30 and 33 is supported in the bed of the truck in a special manner, which is in addition to the flat stock material mounting of the beams 30 and 33 in the bed 27 of the truck as described above. As shown, a toolbox 96 is provided in the bed 27 of the truck. The toolbox 96 is mounted in the bed 27 adjacent to the cab. The toolbox 96 is mounted to the truck frame through the bed 27 in a secure manner similar to the mounting of the flat stock material described above. The toolbox 96 has two openings 99 and 100 near a base thereof, which openings 99 and 100 is reinforced by respective channel members extending in the fore and aft direction. The channel members has large enough openings to receive the beams 30 and 33. Hence the toolbox is secured to the bed 27 of the truck and the underlying frame, and the beams 30 and 33 are additionally be secured to the truck by the tool box 96 and the channel members. The toolbox 96 has lids 103 and 106 for accessing an interior of the toolbox 96. One or more padlocks 109, or other locking device(s), is used to secure one or both lids 103 in a closed condition to protect tools and other components against access by unauthorized persons. Hence, in this embodiment, the fork lift 15 includes tool box 96 positioned on the mounting beams 30 and 33. The tool box 96 is positioned at an opposite ends of the mounting beams 30 and 33 from the fork lift mast assembly 16. The tool box 96 includes first and second channels 99 and 100. The proximal ends of the first and second mounting beams 30 and 33 extending through the first and second channels 99 and 100, respectively.

Hence, fork lift 15 is for attachment to a truck frame 336 (FIG. 5A) of a truck 18. In one embodiment, the fork lift 15 includes a fork lift mast assembly 16 pivotably coupled to first and second mounting beams 30 and 33 through tilt actuators 45 and 46, respectively. The first and second tilt actuators 45 and 46 are connected between the first and second mounting beams 30 and 33, respectively, and the fork lift mast assembly 16. The first and second tilt actuators 45 and 46 are connected to the fork lift mast assembly 16 through fork lift mast brackets 57 and 58, respectively. The fork lift mast assembly 16 is repeatably moveable between positions extending parallel and perpendicular to the truck bed 27 in response to actuating actuators 45 and 46.

In this embodiment, the first and second mounting beams 30 and 33 are carried by the truck frame 336. A truck bed 27 is positioned between the truck frame 336 and the first and second mounting beams 30 and 33. In this way, the first and second mounting beams 30 and 33 are positioned above the truck bed 27 of the truck 18. In this embodiment, the distal ends of the first and second mounting beams 30 and 33 extend beyond the rear of the truck bed 27 (FIG. 5A). The fork lift mast assembly 16 is pivotably connected to the first and second mounting beam 30 and 33 proximate to the rear of the truck bed 27.

In this embodiment, the fork lift 15 includes a plurality of detachable attachment mechanisms 69 connecting the first and second mounting beams 30 and 33 to the truck frame 336. The plurality of detachable attachment mechanisms 69 extend through the truck bed 27 of the truck 18. The truck bed 27 includes an opening through which the detachable attachment mechanism 69 extends. In some embodiments, the detachable attachment mechanisms 69 extend through openings of the truck bed 27. As shown in FIG. 5A, detachable attachment mechanism 69 is positioned between a rear of the truck bed 27 and a rear wheel 287 of the truck. In this way, at least one of the detachable attachment mechanisms 69 is positioned between a rear of the truck bed 27 and a rear wheel 287 of the truck 18. In this embodiment, detachable attachment mechanism 69 extends through the truck bed 27, and has one end engaged with the truck frame 336 and an opposed end engaged with the mounting beam 30 (FIG. 5A). It should be noted that, in this embodiment, another attachment mechanism 69 has an end connected to the truck frame 336 and an opposed end connected to the second mounting beam 33. In some embodiments, the first and second detachable attachment mechanisms 69 extend perpendicular to the first and second mounting beams 30 and 33, respectively. In this embodiment, the first and second detachable attachment mechanisms 69 connect the first and second mounting beams 30 and 33, respectively, to the truck frame 336. In this embodiment, the first and second attachment mechanisms 69 are engaged with the truck frame 336 and first and second mounting beams 30 and 33, respectively.

In this embodiment, the fork lift 15 includes a fork lift carriage 19 carried by the fork lift mast assembly 16. The fork lift carriage 19 is repeatably slideable between raised and lowered positions relative to the fork lift mast assembly 16. The fork lift mast assembly 16 includes a fork lift hydraulic ram 152. The fork lift carriage 19 is repeatably slideable between raised and lowered positions relative to the fork lift mast assembly 16 in response to actuating the fork lift hydraulic ram. In this way, the fork lift carriage 19 slides along the fork lift mast assembly 16 in response to actuating the fork lift hydraulic ram 152.

In this embodiment, the fork lift 15 includes first and second mast chains 250 and 251 which are coupled to the fork lift carriage 19. The first and second mast chains 250 and 251 are coupled between the first and second sliding mast arms 55 and 56, respectively, and the fork lift hydraulic ram 152. The fork lift hydraulic ram 152 is operatively coupled to the fork lift carriage 19 through the first and second mast chains 250 and 251.

In this embodiment, the fork lift mast assembly 16 includes first and second pivot mast arms 21 and 22 pivotably connected to the first and second mounting beam 30 and 33, respectively. In particular, the first and second pivot mast arms 21 and 22 pivotably connected to the corresponding first and second mounting beam 30 and 33 through actuators 45 and 46, respectively. In this embodiment, the first and second pivot mast arms 21 and 22 are C-channel beams.

In this embodiment, the fork lift mast assembly 16 includes first and second sliding mast arms 55 and 56 slidingly engaged with the first and second pivot mast arms 21 and 22, respectively. The first and second sliding mast arms 55 and 56 slide relative to the first and second pivot mast arms 21 and 22 in response to actuating the fork lift hydraulic ram 152. In this embodiment, the first and second sliding mast arms 55 and 56 are I-channel beams.

FIG. 2B is a top plan view including an interior of the toolbox 96 and the beams 30 and 33. The toolbox 96 has an interior 112, (shown in an empty condition in FIG. 2B.) The toolbox 96 is attached to the bed 27 of the truck by angle iron 119 extending along a forward base of the tool box 96. The angle iron 119 is fixed to the tool box and bolted by bolts 121 or otherwise connected to frame members of the truck through the bed 27. Alternatively or additionally, a bottom wall 115 of the toolbox is attached to the bed 27 of the truck by channel iron 118 or flat stock material. The channel iron 118 has holes therethrough corresponding to holes in the bottom 115 of the toolbox and holes through the bed 27 of the truck. Bolts 121 is used to secure the channel iron 118 and the toolbox 96 to the bed 27. The bolts 121 engage a frame of the truck below the bed 27. As shown, The channel members for receiving the mounting beams 30, 33 is closed channels 124 that is fixed to and extend through a bottom portion of the toolbox 96. These closed channels 124 open rearwardly into openings 99 and 100 shown in FIG. 2A. Thus the beams 30 and 33 is received in the closed channels 124 for a secure attachment of the beams 30 and 33 to the truck bed 27 and the underlying truck frame.

FIG. 2B also shows a fifth wheel hitch 127. This fifth wheel hitch 127 is secured directly to the beams 30 and 33, to one or more of a cross member, the flat stock material, and the truck frame through the truck bed 27. To this end, the fifth wheel hitch 127 is secured by bolts 121 or other attachment mechanisms.

FIG. 2C is a diagrammatic top plan view of half of the toolbox 96, generally encompassing a region corresponding to the area of the circle labeled 2C in FIG. 2B. However, FIG. 2C includes components that is located in one side or the other of the toolbox 96. These components include a mast pump 130 that is a single or double acting pump; a tilt pump 133, which is a double acting pump; first and second solenoid valves 136, 139 connected to the mast pump 130 and the tilt pump 133, respectively, and first and second electric motors 142, 145 connected to respective electric solenoid valves 136, 139. A mast hydraulic line 148 extends from the electric solenoid valve 136 to the mast hydraulic ram 152, as is appreciated from viewing FIGS. 2C and 1B. A tilt “in” hydraulic line 155 and a tilt “out” hydraulic line 158 is connected to the electronic solenoid valve 139 and to the one or more tilt hydraulic rams 45.

Electricity is carried to each of the electric motors and each of the electric solenoid valves from the truck's electrical system, a separate electrical system, or a battery by electric lines 161. These lines is connected to a contact strip 164 which is mounted on an inner wall of the toolbox 96 or at any other location. Corresponding electric lines extends from the contact strip to respective control boxes 167 and 170. These control boxes incorporate double pole-double throw spring center toggle switches. The control boxes 167 and 170 is separate from each other or joined together as shown in FIG. 2D. The control boxes 167 and 170 is mounted on a dash board or other stationary location, or they can form pan of a pendant 173 that provides a measure of mobility to the user while operating the controls. In this regard, an electrical cable 176 connecting the power strip 164 to the control boxes 167 and 170 has a length of between 4 feet and 8 feet, for example, to permit a user to control the fork lift 15 from within the cab, outside the cab near the truck bed, or at a small distance from the truck. The cable 176 is connected to the control boxes by a strain relief connection to reduce strain on the wires within.

As shown in FIG. 2D, the spring center toggle switch 171 controls the single acting mast pump motor 142 and valve 136 to cause the mast to move in an upward direction, a downward direction under the influence of gravity, or to remain in a neutral stationary position as indicated by up, down, and central positions labeled on the control box 167. Alternatively, the pump motor 142 is a double acting motor for activation in both directions. Similarly, the spring toggle 172 connected to the tilt pump motor and valve is operated to cause the fork lift 15 to be tilted out, tilted in, or to remain in a stationary position. The corresponding positions for the spring biased toggle 172 are shown in FIG. 2D. Each of the spring toggles 171 and 172 are spring biased to a central neutral position. Therefore, the fork lift will remain in a stationary condition unless a user moves the toggle switches 171 or 172 from the neutral position into up, down, out, or in actuation positions.

It is to be understood that the present invention can incorporate an electric over hydraulic control system in which each position of actuation is in either an “on” or an “off” position. In order to control the speed of actuation of the rams, a restriction in the hydraulic system is provided. Thus, relatively small movements of the fork lift is effectuated. For fine adjustments in position, the toggles 171 and 172 can be bumped on and off for very small incremental changes in positions. Alternatively, a more complex proportional electric over hydraulic system is implemented. Further alternatively, a purely hydraulic actuation system could be incorporated. However, doing so would require hydraulic lines to be routed into the cab of the truck, or to whatever location from which the user would actuate the system.

The electric over hydraulic system is provided by a wireless control system with a wireless control box 177 wirelessly connected to the pumps by a transceiver/converter 178 as shown in FIG. 2E. The transceiver/converter 178 receives and/or transmit radio frequency signals from and to the wireless control box 177 through the air. The transceiver/converter can also convert the signals from radio frequency to command signals that control the solenoids 136, 139 and the motors 142, 145. The transceiver portion of the transceiver/converter can implement a simple receiver in accordance with the present invention.

The control box 177 of FIG. 2E includes elements similar to those described with regard to the control box 167 of FIG. 2D above. For example, the control box 177 includes a spring center toggle switch 379 that controls the single acting mast pump motor 142 and valve 136 to cause the mast to move in an upward direction, a downward direction under the influence of gravity, or to remain in a neutral stationary position as indicated by up, down, and central positions labeled on the control box 177. Similarly, a spring toggle 382 connected to the tilt pump motor and valve is operated to cause the fork lift 15 to be tilted out, tilted in, or to remain in a stationary position. The corresponding positions for the spring biased toggle 382 are shown in FIG. 2E. Each of the spring toggles 379 and 382 are spring biased to a central neutral position. Therefore, the fork lift will remain in a stationary condition unless a user moves one or more of the toggle switches 379 and 382 from the neutral position into up, down, out, or in actuation positions. As shown, the control box 177 includes additional buttons for controlling the fork lift 15. For example, a bypass button 385 is provided for bypassing a restriction in the lines that usually slows the rate at which the ram moves. Thus, the bypass button 385 is pressed to increase a speed of descent of the forks when, for example, they have no load so that they would otherwise descend slowly. Another safety or activation button 388 is provided on a different face of the control box 177. In order to actuate the system in any way with the switches 379, 382, and possibly even bypass button 385, a user is required to also press the safety button 388. It is required to hold down the safety button 388 in order for power to be supplied to the other switches 379, 382 and/or bypass button 188. An additional main manual on/off switch is provided on an outside of the tool box 96, for example, to provide power to the system including the control box 177. It is to be understood that the control box 71 shown in FIG. 1A includes the same features described with regard to the control box 177 and varies therefrom in that the control box 71 of FIG. 1A is connected to the hydraulics components by wires.

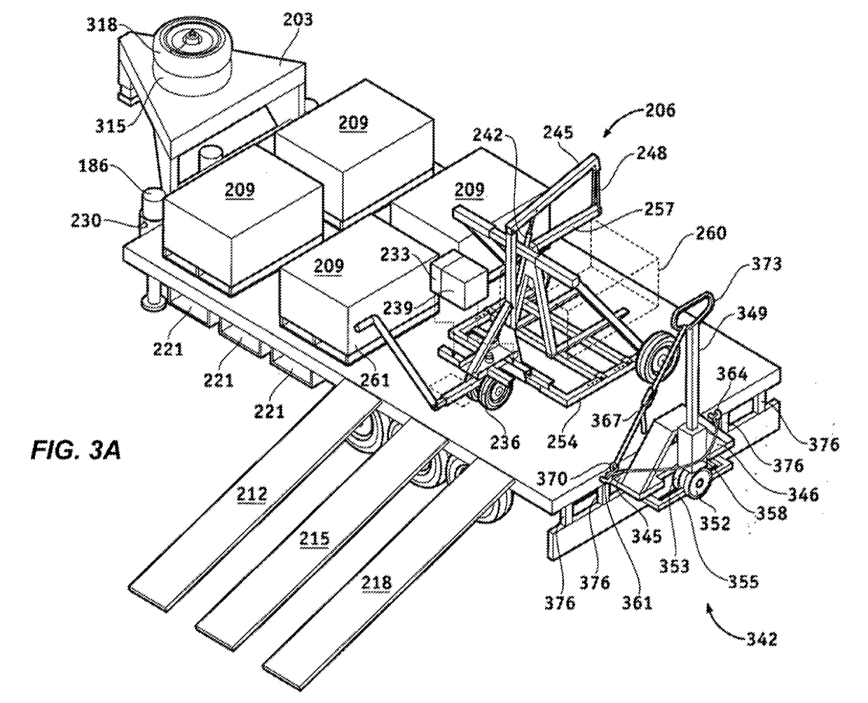

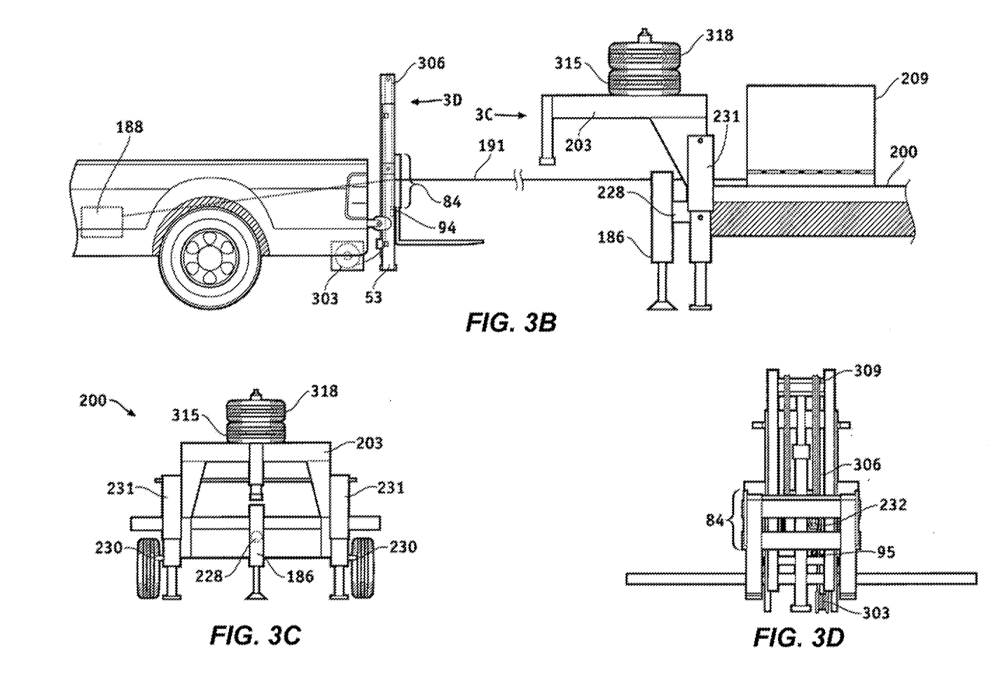

As shown in FIG. 2C, a larger hydraulic reservoir 179 is implemented with the present system to accommodate the large capacity of the mast lift hydraulic ram 152 and the one or more tilt rams 45 of the fork lift 15. Additionally, a diverter valve 182 with a manual lever 185 is provided to manually swap the connection of the mast pump to one or more trailer supporting rams as will be described in greater detail below. The diverter valve 182 is connected to each of the fork lift hydraulic ram 152 and one or more trailer supporting hydraulic rams 186 as shown in FIG. 1B, and as shown and described below in greater detail. It is to be understood that the diverter valve 182 includes a solenoid and is controlled from the control box 71, 173, or 177 similarly to the control of the pumps and valves associated with motors 142, 145. The toolbox 96 also includes a winch 188 supported therein, and a winch cable 191 is extended through a wall of the toolbox 96 as shown in FIG. 2C. Among other things, the winch 188 can be used to pull a loaded pallet along a trailer bed by way of the cable 191, as shown and described with regard to FIG. 3B below.

The truck fork lift 15 in combination with the truck 18 is used together with other devices shown in FIGS. 3A-5B to provide a more comprehensive lifting and hauling system. As such, the hauling system includes a trailer 200 with a goose neck tongue 203 for a connection with the fifth wheel hitch 127. The system also includes a pallet buggy 206, which is carried on the trailer 200 together with a load which includes pallets 209, for example. The trailer includes stowable ramps 212, 215, and 218, which can be slid into ramps carriers 221 for storage during periods of transport and non-use. It is to be understood that the ramps 212, 215, and 218 and the ramp holders 221 is located at any position along the trailer. In particular, it is to be understood that the trailer will need to be loaded with a greater amount of the overall weight centered slightly forward from the center of the trailer. Thus, it is to be understood that the relative positions of the loaded pallets 209 and the pallet buggy 206 can be varied depending upon the particulars of the load to be carried. The trailer 200 is any of a variety of trailers, but should have a rating greater than or equal to any maximum that will be hauled on the trailer for safety purposes.

As shown in FIG. 3A, one or more trailer supporting rams 186 is provided at respective corners of the trailer. Alternatively, a trailer ram 186 could be provided generally centrally located along a front edge of the trailer bed as shown in FIGS. 3B and 3C. FIG. 3C is a diagrammatic end view of the trailer 200 taken generally in a direction of arrow 3C of FIG. 3B. The rams 186 has a stowed position in which the rams are retracted upwardly and a position of use in which the rams are slid downwardly through a sleeve 227 and locked in a position of use by a pin 230 as shown in FIG. 3A, for example. The rams 186 could alternatively be mounted to rotate in and out of a position of use on a pivot 228 as shown in FIGS. 3B and 3C. Thus, when it is desired to remove a loaded trailer 200 from a truck, the trailer and load is supported by the trailer rams 186 and moved to an unhitched condition by the rams 186. Actuation of the rams 186 is provided by a hydraulic pump such as the mast pump 130. As indicated above, a diverter valve 182 is provided to alternatively connect the pump 130 and solenoid valve 136 of the mast hydraulic ram 152 to the trailer hydraulic rams 186. The trailer hydraulic rams 186 is simultaneously fed by a single line 148 that is divided severally into as many lines as there are trailer rams 186. It is to be understood that additional trailer rams 186 could be provided at rear corners or elsewhere on the trailer for increased stability and/or versatility.

As shown in FIGS. 3B-3C, manually slideable telescoping stands 231 includes pins 230 for manually adjusting an extent of the stands 231 in a downward direction to engage the ground in a position of rest after the trailer ram(s) 186 have been used to raise the trailer. Once the stands 231 have been extended, the trailer ram(s) 186 is released. Thus, the trailer is provided with a great degree of stability while loading and unloading. As shown in FIG. 3B, the winch cable 191 is routed from the winch to a loaded pallet 209 and engaged around a base of the pallet 209 for the purpose of moving the pallet along a bed of the trailer 200. Thus, the pallet 209 is repositioned or oriented for engagement with the forks of the truck fork lift 15. In order to protect the fork lift ram 152, the winch cable 191 is threaded through a guide 232 that holds the winch cable 191 out of engagement with the fork lift ram 152 while pulling the pallet 209, for example. The winch cable guide 232 is supported on a lower edge of the fork lift plate 84 as shown in FIG. 3D, which is a view of the fork lift mast taken generally in a direction of arrow 3D of FIG. 3B.

As shown in FIGS. 3B and 3D, the truck fork lift 15 includes a take up reel 303 that is mounted on an underside of a rear portion of the truck frame or bed 27. This take up reel is biased to draw in a line 306 that has one or more video cables and power to the one or more respective cameras 92, 94, 95, 97 shown in FIG. 1A. Thus, the video and power cables is fed into an inner end of the line 306 on the take up reel 303. As the mast is raised or lowered, an outer end of the line 306 is withdrawn from the reel 303 to provide the needed slack as the camera is moved together with the mast 21, fork 24, or fork plate 84. The line 306 extends over a pulley 309 that is rotatably mounted on a shaft 312 that also supports one or more chain pulley for lifting the fork plate 84. Likewise, as the fork plate is moved in a direction requiring a shorter length of the line 306, the take up reel 303 will automatically retract and wind a portion of the line 306 on the take up reel 303. In this way, the take up reel 303 reduces the chances of a loose line that iscome tangled or drag on the ground during use of the truck fork lift 15. At the same time, continuous viewing of images is provided as the forks are adjusted to greater or lesser heights, without the need of keeping track of the lines to the camera.

When the take up reel 303 is mounted under a rear portion of the truck bed 27, the customary location for the truck spare tire will be occupied by the take up reel 303 and the housing that supports the take up reel 303. As shown in FIGS. 3A, 3B, and 3C, one or more spare tires 315, 318 is supported on the trailer goose neck 203. For this purpose, a post 321 is supported on and extend upwardly from the goose neck 203. Thus, spare trailer and/or truck tires 315, 318 is conveniently supported for easy retrieval, as needed.

FIG. 3A also shows a manual pallet dolly 342 that is supported on a rear of the trailer 200. The pallet dolly 342 has a pair of forks 345, 346 configured to engage in a pallet. The pallet dolly also has a jacking handle 349 that jacks up a load placed on the forks and also steers the dolly during use. A pair of closely spaced wheels 352, 353 are connected to the jacking handle. This pallet dolly is known, but is not typically supported on a trailer in the manner shown in FIG. 3A. There are three primary securing mechanisms that safely hold the pallet dolly on the trailer 200. Firstly, a stopping cross bar 355 is mounted on a bumper 356 in a downwardly and rearwardly extending position. As shown, the closely spaced wheels 352, 353 straddle the stopping cross bar 355 and engage the stopping cross bar generally at an axle between the wheels 352, 353 under the force of gravity. This mechanism will inhibit separation of the pallet dolly from the trailer 200 under most circumstances during pulling of the trailer 200 by a truck. Secondly, the pallet dolly 342 is secured by a blocking cable 358 permanently connected to a first ring 361 mounted on the trailer bed frame and removeably connected to a second ring 364 mounted to the trailer bed frame. The connections is formed by cable clamps and openable links, for example. As shown, the cable forms a support strap that engages the pallet dolly on a rear side thereof and extends forwardly and laterally outward to the rings 361, 364 when the blocking cable 358 is in a connected state. As such, even if the closely spaced wheels 352, 353 were to clear the stopping cross bar 355 during a bumpy ride, for example, the blocking cable would prevent rearward movement of the pallet dolly away from a rear end of the trailer 200. Thirdly, a tightenable strap 367 having a hook 370 connected thereon is looped through a closed ring 373 of the jacking handle 349. The hook is engaged in the first ring 361, and the strap is tightened to provide a securing tension that will hold the pallet dolly in place on the trailer. The bumper 356 is mounted on the trailer 200 by vertical spacers 376 that form spaces between an underside of the bed of the trailer and the bumper 356. These vertical spacers 376 is located close to outer sides of the pallet dolly in order to inhibit sideway movement of the pallet dolly 342 when the trailer 200 is being pulled with the pallet dolly 342 supported thereon.

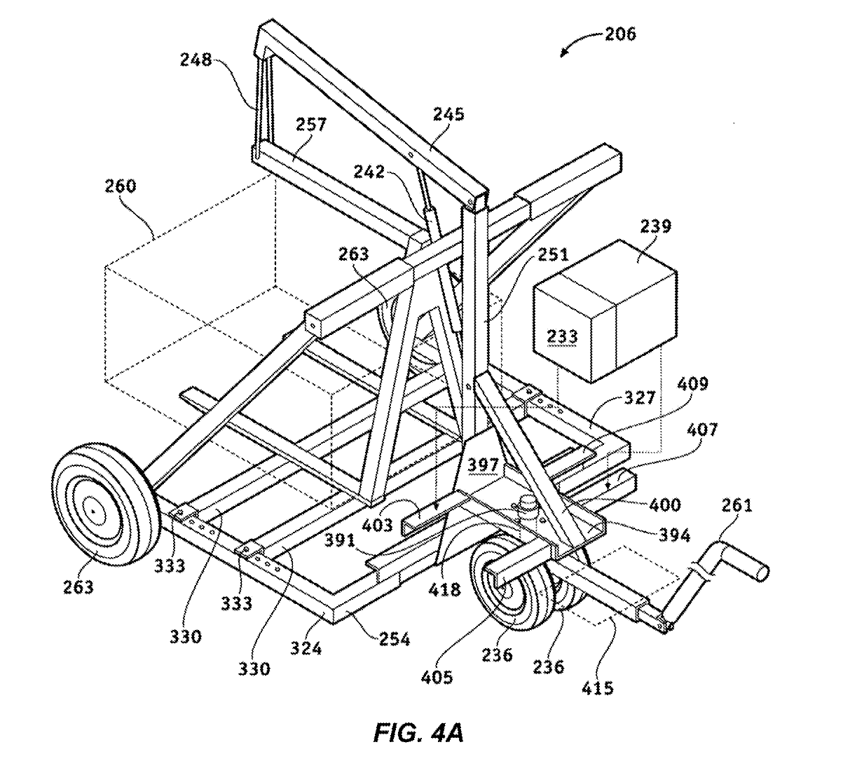

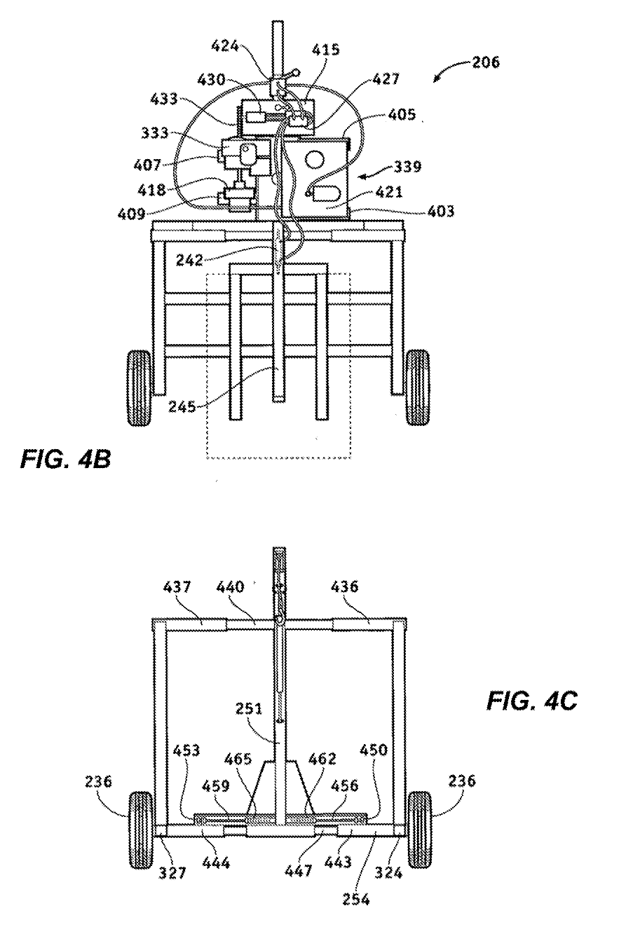

As shown in FIGS. 3A and 4A-4C, the pallet buggy 206 is powered by a motor 233 that drives a wheel 236. The motor also runs a hydraulic pump and reservoir system 239 that is connected to a buggy ram 242. The buggy ram 242, in turn, raises and lowers a buggy crane arm 245. A proximal end of the buggy crane arm 245 is pivotally connected to a vertical frame member 251 of the pallet buggy frame 254. The buggy crane arm 245 has a cable 248 connected to a distal end thereof. A lower end of the cable 248 is connected to a suspended fork 257, which engages and supports a load such as pallet 260, as shown in FIGS. 3A and 4A-4C. Thus, actuation of the pallet buggy ram 242 raises or lowers the crane arm 245 and the suspended pallet fork 257 to raise or lower the load 260, as desired.

The pallet buggy 206 advantageously provides a device that can be maneuvered into and out of tight spaces for picking up and moving loads. For example, if a load needs to be moved into a shelter or structure that has a low clearance opening, the pallet buggy 206 is well adapted for delivering a load into such a structure. The pallet buggy 206 is also an all-terrain vehicle that can maneuver over contours and soil hardness of great variation. The pallet buggy 206 can also be maneuvered and steered by a steering lever 261, for example, connected to the rear wheel(s) 236 in order to navigate turns. On the other hand, front wheels 263 are positioned to support the frame 254 of the pallet buggy. The motor 233 and the hydraulic system 239 is mounted on a platform that is pivotally connected to the frame 254 by a vertically oriented pin, for example. Thus, the turning is effected by pivoting a rear portion of the pallet buggy relative to a front end thereof.

The frame 254 is configured to support loads of three times or more than a weight of the pallet buggy 206 itself. That is, the pallet buggy can weigh a 1,000 pounds or less while being able to support and transport loads of 3,000 pounds or greater. As shown in FIGS. 4A-4C, the pallet buggy frame 254 has outer lateral frame arms 324, 327 that generally straddle a load 260 to be born. Then the load 260 is raised, and load platform cross bars 330 is placed below the load 260 and locked into place on the frame arms 324, 327 by pins 333, for example. Then the load 260 is lowered onto the load platform cross bars 330 for transport. The load platform cross bars 330 is formed of closed or open channel members with upside down L-sectioned end brackets stoppingly engaging an upper surface of the frame arms as shown in FIG. 3E.

As shown in FIG. 4A, steering of the pallet buggy is achieved by a articulating the rear wheels 236 relative to the frame 254. A steering pivot assembly 391 is mounted to an underside of a channel member 394. A steering shaft 395 can extend downwardly and be pivotable with the wheels 236 about a vertical axis, while a hub of the pivot assembly can protrude upwardly through the channel member 394. The steering pivot shaft 395 of the steering pivot assembly cab pivot on a generally vertical axis. The channel member 394 is mounted to the frame 254 by a gusset member 397 and an angled member 400 for increased strength. Motor and hydraulic support members 403, 405, 407, and 409 is fixed to the channel member 394. These members 403, 405, 407, and 409 can receive and support the motor 333, and the hydraulic pump and reservoir 339, as shown. A hydraulic motor and valve platform 412 is slidably supported on a steering bar 415 rigidly connected to the steering shaft 395. The steering lever 261 is connected to an outer end of the steering bar 415.

FIG. 4B shows a top plan view of the pallet buggy 206 with the motor 333 and the hydraulic pump and reservoir supported on the support members 403, 405, 407, and 409. The motor 333 drives a hydraulic pump 418, which draws hydraulic fluid from a reservoir 421 and moves it through a closed loop. A lever control valve 424 controls whether the hydraulic fluid is routed directly back through the reservoir 421, when in a neutral position, or in one of first and second directions through a diverter valve 427. When the lever control valve 424 is pulled all the way back, the fluid is forced in a direction to raise a load or drive the wheels 236 in a rearward direction. When the lever control valve 424 is pushed all the way forward, the fluid is forced in a direction to lower the load or drive the wheels in a forward direction. The diverter valve 427 determines whether the fluid is routed to the pallet buggy ram 242 or to the a hydraulic motor 430. Thus, the diverter valve also provides a safety mechanism. That is, the pallet buggy 206 in this configuration cannot lift by the pallet buggy ram 242 and drive the pallet buggy wheels 236 at the same time. When the diverter valve routes the fluid toward the hydraulic motor 430, the hydraulic motor 430 can drive the wheels 236 by a chain 433, for example. The direction of the driving force is adjusted by the user as he engages the lever control valve 424. Similarly, the user can selectively raise or lower the crane arm 245 with the same lever control valve when the diverter valve has been adjusted to route the fluid through the ram 242.

FIG. 4C is a front plan view taken along a direction of arrow 4C of FIG. 4B. As shown, the frame 254 is a laterally expandable frame in which a spacing of the lateral frame arms 324, 327 is adjusted to match a load width as needed. Upper cross bar sleeves 436, 437 slidably engage an upper cross bar 440. Similarly, lower cross bar sleeves 443, 444, slidably engage a lower cross bar 447. To adjust the width of the pallet buggy, forces is removed from the frame by hoisting the buggy 206 nearly or completely out of engagement with a ground surface. Then the user can engage heads 450 and 453 with a power wrench or other turning device, and turn threaded shafts 456 and 459 in or out of threaded sleeves 462 and 465, respectively. At a most retracted position, the threaded shafts engages a stop, which is provided by an outer wall of the vertical frame member 251. In this position, the pallet buggy is narrow enough to fit in a standard width bed of a pick up truck for easy hauling the pallet buggy.

FIG. 5A is a side plan view and FIG. 5B is a top plan view of a stanchion 266 for supporting and storing the truck fork lift 15 when it is not mounted to the truck 18. The stanchion 266 includes two elongate skids 269, 270 in the form of channel members. A plurality of vertically extending frame members 272 and 275 is fixed to the skids 269, 270 and extend upwardly therefrom. Diagonal strengthening members 278 can also extend in a vertical direction as well as a horizontal direction diagonally up from the skids 269 to a horizontal frame member 281. The skids 269, 270, and the combination of vertical, horizontal, and diagonal frame members 272, 275, 278, and 281 supports fork receivers 284. The fork receivers 284 is rectangular tubular channels with open ends to receive the forks 24 of the truck fork lift 15.

Thus, a truck 18 is backed up so that the forks 24 are stabbed into the receivers 284. Then the truck fork lift is operated to transfer the load of the fork lift 15 to the stanchion. Before the load is transferred in this manner, the bolts 69 that secure the beams 30, 33, and/or flat stock material is removed from the truck frame 336 by disengaging a nut 339 that is welded or otherwise secured to the truck frame 336, as shown in FIG. 5A. Any hydraulic lines is disconnected from the hydraulic pumps, and any electrical and video cables is disconnected. The hydraulic lines to the truck fork lift 15 is disconnected by a quick disconnect, for example. All loosening of the bolts and disconnections of the lines is easily made within approximately three minutes. And it can take only ten minutes to completely remove the fork lift including the mast and mounting beams together with the hydraulic rams and the components mounted to these members. The hydraulic pumps, controls, and monitor can remain connected to the truck. In separating the truck fork lift from the truck, the beams 30 and 33 is slid out of the channels 124 in the toolbox 96, when the channels 124 form part of the mounting of the truck fork lift 15. As shown in FIGS. 5A and 5B, the skids 269, 270 is set at a width narrower than the rear wheels 287 of the truck 18 so that the truck can generally straddle the skids 269, 270 during transfer of the truck fork lift 15 from the truck bed onto the stanchion 266. As shown by dashed lines in FIGS. 5A and 5B, the fork receivers 284 is positioned fore or aft on the frame members of the stanchion 266, depending upon the desired load distribution.

FIG. 5C is a diagrammatic side view of the fork lift stanchion of FIG. 5A for supporting the fork lift of FIGS. 1A, 1B and 1C in a condition separate from the truck. In this embodiment, flat stock material 66 and 60 is shown positioned as discussed in more detail above. Flat stock material 66 and 60 is positioned between the mounting beams 30 and 33 and truck bed 27.

### Exemplary Methods for Delivery Service

The electric over hydraulic solenoid valves create a flexibility to remotely operate the forks from the cab or from outside the truck. Sometimes this option is needed because of a particular terrain in which stabbing a pallet is facilitated by viewing the action from a particular vantage point. Thus, loading or unloading pallets on uneven terrain can be facilitated by utilizing a cable remote control or wireless remote control system.

### Truck Forklift, Pallet Buggy, and Trailer Operation

Four pallets is loaded on the trailer at a warehouse and transported to a delivery site. The driver/user of a truck can pull in front of a driveway. The pallet buggy is unloaded and placed in a garage in which the pallets are to be placed. (An ideal parked unload position in a residential subdivision is in a cul de sac with trailer centered for easy access to both sides of the trailer. Otherwise, the pallets may need to be pulled to an accessible side of the trailer by a winch and winch cable similar to that described above.) The driver/user can leave the truck running and turn a power switch of the system “on” to enable operation. Then the user can disconnect safety chains and any electrical connection between the truck and trailer. The user can deploy a drop jack “hydraulic cylinder” or ram on the trailer and make a hitch of the truck and trailer ready for release so that the trailer tongue is raised. It is important to remember that the trailer is loaded with up to 12,000 pounds of product.

The driver can use a quick disconnect hydraulic hose extending from the trailer hydraulic cylinder or ram to an auxiliary hydraulic output to raise and lower the trailer. The driver can raise the trailer and then disconnect the auxiliary hydraulic hose. Then the user can move the truck forward and unfold each fork from a transport position to a working position and remove securing straps from a palletized product on the trailer.

The user can back the truck up to either side of the trailer, centering on the rear pallet first. By viewing a camera monitor within the cab, the user can position the forks to stab the pallet. The user can slowly back up to the pallet while viewing a screen of the monitor. Once, a pallet has been stabbed and raised at least slightly with the forks, the user can drive slowly to a position about five feet away from trailer. Then he/she can lower the pallet to a height of approximately two feet from the ground. With the load in this position, the driver can then drive approximately five miles per hour or slower into the garage and place the pallet inside.

By always viewing the monitor as he/she is placing the loaded pallet on the garage floor, a user can avoid striking the house or garage. Likewise, the hydraulic pressure enables the user to selectively control a height of the truck fork lift including the mast. The mast is configured to not exceed approximately seventy-nine inches in height when the truck is unloaded so as not to hit the garage door when the truck is pulled in and out of the garage. Other mast heights is smaller or larger than seventy-nine inches.

Depending on a terrain of the ground over which the load is to be transported by the truck fork lift, a strap is used to wrap around the palletized load and the forklift mast to stabilize the load. In this case, the strap would need to be removed before leaving the garage. Then the user can return to the trailer in the truck and repeat the above described procedure. This method of operation can reduce the unloading time approximately fifteen to twenty minutes per delivery as compared to a method that uses a crane. More importantly, the user or operator can remain in the cab when moving and unloading the pallet from the forks.

In some cases, the palletized loads can need to be placed in a garage having a vertical clearance lower than the minimum height of the truck fork lift mast, or the loads can need to be maneuvered in a manner that is difficult to achieve with the truck fork lift. In these cases, the palletized load is set on the ground at any convenient location, and the pallet buggy is used to engage, lift, place the load on a support frame of the pallet buggy, and transport the load to a location for final placement of the delivery. As such, the pallet buggy is used to move the pallet into the garage when a passage is too narrow for the truck fork lift, for example. In a case where there is no paved driveway, the truck is backed up to a sheet of plywood that has been previously placed on a pair of flat pallets, for example. The palletized load is placed on the sheet of plywood by the truck fork lift. Then the palletized load is moved with the pallet buggy into the location of final placement of the delivery within the garage.

The embodiments of the invention described herein are exemplary and numerous modifications, variations and rearrangements can be readily envisioned to achieve substantially equivalent results, all of which are intended to be embraced within the spirit and scope of the invention as defined in the appended claims.

1. A fork lift for attachment to a truck frame of a truck, comprising:
A first mounting beam carried by the truck frame;
a detachable attachment mechanism connecting the mounting beam to the truck frame, the detachable attachment mechanism extending through a truck body of the truck;
a fork lift mast pivotably connected to the mounting beam; and
a tilt actuator connected between the mounting beam and fork lift mast.

2. The fork lift of claim 1, wherein the truck body is positioned between the truck frame and mounting beam.

3. The fork lift of claim 1, wherein the truck is a pickup truck.

4. The fork lift of claim 1, wherein the detachable attachment mechanism extends perpendicular to the mounting beam.

5. The fork lift of claim 1, wherein at least one of the detachable attachment mechanism is positioned between a rear of the truck body and a rear tire of the truck.

6. The fork lift of claim 1, wherein the fork lift mast is pivotably connected to the mounting beam proximate to the rear of the truck body.

7. A fork lift for attachment to a truck frame of a truck, comprising:
a mounting beam positioned on a truck body of the truck;
a detachable attachment mechanism extending through the truck body, the detachable attachment mechanism having one end connected to the truck frame and an opposed end connected to the mounting beam;
a fork lift mast pivotably connected directly to the mounting beam; and
a tilt actuator connected directly between the mounting beam and fork lift mast.

8. The fork lift of claim 7, wherein the truck body includes an opening through which the detachable attachment mechanism extends.

9. The fork lift of claim 8, wherein the detachable attachment mechanisms extend perpendicular to the mounting beam and through the opening.

10. The fork lift of claim 7, further including a truck frame and truck body, wherein the truck body includes a truck bed through which the detachable attachment mechanism extends.

11. The fork lift of claim 10, wherein the fork lift mast is repeatably moveable between positions extending parallel and perpendicular to the truck bed.

12. The fork lift of claim 7, further including a tool box positioned on the mounting beam.

13. The vehicle of claim 12, wherein the tool box is positioned at an opposite end of the mounting beam from the fork lift mast.

14. A fork lift for attachment to a truck frame of a truck, comprising:
first and second mounting beams positioned on a truck bed of the truck, the truck bed being carried by the truck frame;
first and second attachment mechanisms extending through the truck bed, the first and second attachment mechanisms having ends connected to the truck frame and opposed ends connected to the first and second mounting beams, respectively;
a fork lift mast pivotably connected to distal ends of the first and second mounting beams; and
first and second tilt actuators connected between the first and second mounting beams, respectively, and the fork lift mast.

15. The fork lift of claim 14, further including a truck frame and truck bed, wherein the truck bed is positioned between the truck frame and the first and second mounting beams.

16. The fork lift of claim 14, wherein the first and second detachable attachment mechanisms extend perpendicular to the first and second mounting beams, respectively.

17. The fork lift of claim 14, further including a tool box engaged with a proximal end of the first and second mounting beams.

18. The fork lift of claim 17, wherein the tool box includes first and second channels, the proximal ends of the first and second mounting beams extending through the first and second channels, respectively.

19. The fork lift of claim 14, wherein the distal ends of the first and second mounting beams extend beyond the rear of the truck bed.

20. The vehicle of claim 15, further including flat stock material positioned between the first and second mounting beams and the truck bed.
